(19) United States
(12) Patent Application Publication
(10) Pub. No.: US 2005/0077762 A1
(43) Pub. Date: Apr. 14, 2005

(54) Head rest for the seat of a vehicle

(75) Inventors: Bernd Kraemer, Zingsheim (DE); Alfred Scholi, Mulheim/Ruhr (DE); Jan Thunnissen, Wanssum (NL)

Correspondence Address: FOLEY & LARDNER, 777 EAST WISCONSIN AVENUE, SUITE 3800, MILWAUKEE, WI, 53202-5308, US

(73) Assignee: Johnson Controls GmbH

(21) Appl. No.: 10/503,519

(22) PCT Filed: Feb. 4, 2003
(86) PCT No.: PCT/EP03/01081

(30) Foreign Application Priority Data
Feb. 5, 2002 (DE) 102 04 724.3

(51) Int. Cl. B60N 2/42

(52) U.S. Cl. 297/216.12

(57) ABSTRACT

In the case of a head restraint which is connected to the backrest (5) of a vehicle seat, a padded segment (9) which can be changed in position relative to the basic body (1) of the head restraint can be shifted, in the event of an accident, under the action of a force-generating device from the use position toward the seat occupant's head (10) into a safety position and can be locked therein by means of a fixing device. According to the invention, the fixing device comprises a telescope (11) which, on the one hand, is supported on the basic body (1) and, on the other hand, is connected to the shiftable padded segment (9), it being possible for the resetting forces (F_{R}) which act on the padded element to be introduced into the telescope in a direction deviating from the telescope axis (X).

### CROSS-REFERENCE TO RELATED PATENT APPLICATIONS

This application is the U.S. National Phase of International Application No. PCT/EP03/01081, filed Feb. 4, 2003 and claiming priority to German application No. DE 10204724.3 filed Feb. 5, 2002, and German application No. DE 10215137.7, filed Apr. 5, 2002, all of which are incorporated herein by references.

### BACKGROUND OF THE INVENTION

The invention relates to a head restraint which is connected to the backrest of a vehicle seat, having a padded segment which can be changed in position relative to the basic body of the head restraint and, in the event of an accident, can be shifted under the action of a force-generating device from the use position toward the seat occupant's head into a safety position and can be locked therein by means of a fixing device.

Laid-open specification DE 39 00 495 A1 discloses a head restraint of the generic type for a motor vehicle seat. The head restraint comprises a padded basic body connected to the backrest of the seat via downwardly protruding holding rods. A separate padded element is arranged in a recess of the basic body by means of a piston-cylinder arrangement or a pivoting mechanism in such a manner that it can be moved about a horizontal axis (Y-axis) orientated transversely with respect to the longitudinal axis of the vehicle. If a sensor situated in the vehicle anticipates an accident situation, the padded element is rotated under the action of a spring or a pneumatically or hydraulically volume-changeable bellows from the comfortable use position toward the seat occupant's head into a safety position (supporting position) and is locked in this position by means of a mechanically acting fixing device comprising a latching lug and blocking element. The shortening of the distance between the head restraint and head brings about an anti-whiplash effect, i.e. prevents the over-extension of the upper spinal column in an accident situation.

Latching devices of this type are structurally complex and furthermore cannot be latched in an infinitely variable manner. It can therefore not be ruled out that the latching is not securely engaged in the supporting position.

The invention is based on the object of providing a fixing device of the generic type which permits a simple structural design, reliable functioning and a simple resetting of the head restraint after the end of the accident situation.

### SUMMARY OF THE INVENTION

According to the invention, the object is achieved in the case of a head restraint according to the precharacterizing clause of claim 1 by the fixing device comprising a telescope which, on the one hand, is supported on the basic body, and, on the other hand, is connected to the shiftable padded segment, it being possible for the resetting forces which act on the padded element to be introduced into the telescope in a direction deviating from the telescope axis. Under the action of the forces which are exerted by the seat occupant's head on the padded element and are introduced asymmetrically into the telescope, the latter is deformed and prevents an undesirable shifting back of the padded element.

A force-transmitting device which acts on the telescope, according to a first preferred variant of the invention, advantageously has a bolt which connects a flange plate, which is arranged on the end side of the telescope in the direction of travel, and the shiftable padded segment to each other eccentrically with respect to the telescope axis. Even if the padded element and the flange plate are aligned with each other for optical or structural reasons, the transmission of force from the padded element into the flange plate and therefore into the telescope takes place eccentrically.

According to a further variant of the invention, the telescope (11) is inclined with respect to the horizontal (X direction of the vehicle). In this case, the inclination can be 10° to 45°, preferably approximately 20° to 25°, and in conjunction with the largely horizontally acting resetting force caused by the occupant's head, leads, in the supporting position, to the telescope becoming blocked.

In principle, the term “telescope” comprises any arrangement of components which are connected to one another via sliding guides and can be displaced with respect to one another and which, under an eccentrically and/or obliquely applied counter force, ensure self-locking against a return movement.

A telescope of this type advantageously comprises a number of preferably circular tube sections which are displaceable one inside another, are essentially pushed one inside another in the use position and are pulled out of one another when the safety position is adopted. Even with the tube surfaces having the surface roughnesses which are customary in manufacturing, a telescope of this type has a tendency to be deformed if it is loaded eccentrically or obliquely. Specific structuring of the tubes, for example, by inserting annularly encircling depressions (machining on the lathe) enables this effect to be reinforced with little effort.

The tube sections do not inevitably have to have a cylindrical form. If the padded segment is to execute a curved movement rather than a linear displacement, the telescope and the associated tube sections which are movable one inside another may also be formed corresponding to a segment of a torus. In this case, the telescope axis would have a curved profile. However, with respect to the manufacturing process, the use of a linear length-changeable telescope is to be preferred.

The force-generating device required for the extension of the padded element preferably comprises one or more compression springs which are prestressed into the use position and with which, in particular, a displacing force which acts centrically with respect to the telescope axis and does not deform the telescope can be generated. The arrangement of a single compression spring which surrounds the telescope coaxially with respect to the telescope axis is particularly favorable. In principle, however, any other desired designs of energy stores can also be used, for example tension springs, compressed air storage systems or pyrotechnic devices.

In order to correct the head restraint after the end of the accident situation, according to one particular design of the invention, a restoring force (F_{RH}) which acts centrically with respect to the telescope axis (X) can be applied to that end of the telescope (11) which faces the padded element (9). This restoring force may be generated, for example, by means of a probe which is guided centrally through the telescope from the rear side of the head restraint, is temporarily connected to the relevant end of the telescope and is subsequently pulled back until the padded element, under renewed prestressing of the force-generating device, latches in the use position.

In order to make the setting of the head restraint in the use position as comfortable as possible, it is furthermore proposed that the head restraint is connected to the backrest by means of holding rods preferably in a manner such that it can be adjusted infinitely variably in height. It is furthermore proposed that the head restraint is connected to the backrest preferably in a manner such that it can be rotationally adjusted infinitely variably about an axis of rotation.

### BRIEF DESCRIPTION OF THE DRAWINGS

The figures illustrate schematically different variants of the invention by way of example.

FIG. 1 shows an exemplary embodiment of a head restraint in the use position

FIG. 2 shows the head restraint according to FIG. 1 in the safety position

FIG. 3 shows an alternative exemplary embodiment of a head restraint in the safety position.

### DETAILED DESCRIPTION OF THE PREFERRED EMBODIMENTS

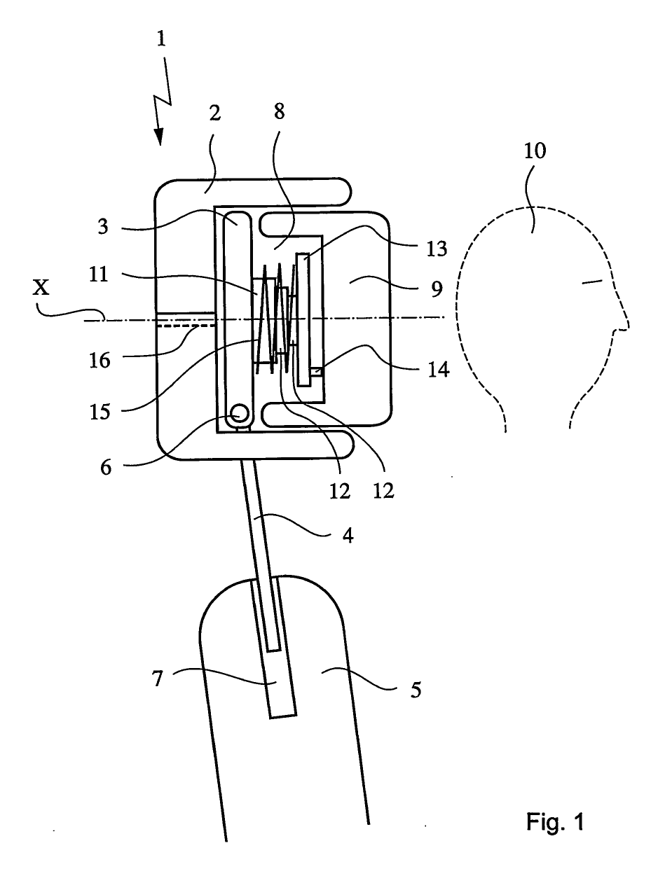

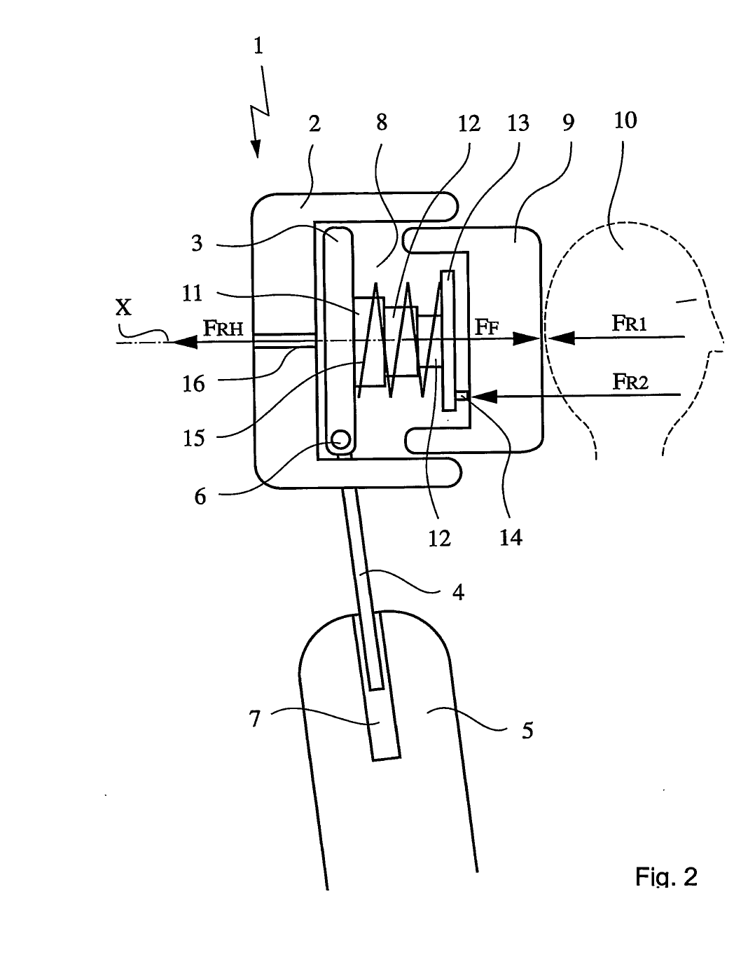

The head restraint depicted in FIGS. 1 and 2 comprises a basic body 1 which comprises a padding 2 and a metallic carrier element 3 connected to the latter. The plate-like, essentially vertically orientated carrier element 3 is connected to the backrest 5 via holding rods 4 and can be locked in different inclinations in an infinitely variably adjustable joint 6 in order to improve the comfort. The height of the head restraint can furthermore be matched to the seat occupant's height by means of a likewise infinitely variably adjustable and lockable linear guide 7.

On the front side, i.e. the side facing the seat occupant, the basic body 1 has a cuboidal recess 8 in which a padded segment 9 is arranged in a manner such that it can be displaced longitudinally in the direction of the seat occupant's head 10.

A tubular telescope 11 which comprises a number of tube sections 12 which can be displaced longitudinally one inside another horizontally in the direction of the telescope axis X is arranged on the front side of the carrier element 3. The telescope is orientated centrally with respect to the center of the carrier element 3 and, at its forwardly protruding, free end, is connected centrically to a flange plate 13 arranged parallel to the carrier element 3. Said flange plate, for its part, is aligned with the displaceable padded segment 9 and is attached rigidly thereto by means of a bolt-like force-transmitting device 14 orientated eccentrically with respect to the telescope axis X.

Furthermore, a compression spring 15 which surrounds the telescope 11 coaxially with respect to the telescope axis X is arranged between the carrier element 3 and flange plates 13. Said compression spring is supported, on the one hand, on the carrier plate 3 and, on the other hand, on the flange plate 13 and can be fixed under prestress (FIG. 1) by means of a locking device (not illustrated). In this position (use position), the padded segment 9 is at a relatively large distance from the seat occupant's head 10.

In an accident situation, unusually high acceleration forces occur in the vehicle and are detected by a sensor. When an acceleration limit value is exceeded, a control in operative connection with the sensor immediately releases the locking device and brings the head restraint into the safety position.

Sensors, controls and locking devices of this type are disclosed, for example, in the publication DE 200 02 171 U1 to which express reference is hereby made.

After the locking device is released, the padded segment is displaced, as can be seen from FIG. 2, by the relaxing compression spring 15 in the direction of the head 10 in order to adopt the safety position. In the process, the tube sections slide apart as a consequence of the spring force F_{F}, which is generated by the compression spring and acts forward centrically with respect to the telescope axis X, until the padded segment adopts an end position which is defined by a stop (not illustrated). The seat occupant's head 10, which impacts against the padded element in the course of the accident situation, in the process generates a rearwardly directed resetting force F_{R1}, under the action of which an undesired shifting back of the padded segment 9 could occur. However, the resetting force F_{R1} is introduced from the padded segment 9 by means of the eccentrically arranged force-transmitting device 14 via the flange plate 13 in an axially offset manner (resetting force F_{R2}) into the telescope 11. The tube segments 12 of the telescope 11 become jammed under this loading in such a manner that further sliding one inside another and therefore a shifting back of the padded segment 3 when the head 10 strikes against it is prevented.

After the end of the accident situation, the padded segment 9 can be guided back into the use position by a probe being introduced from the rear side of the head restraint through a hole 16 running coaxially with respect to the telescope axis X into the recess 8 and being connected centrically to the flange plate 13, for example by screwing into a corresponding thread. By the probe being pulled back (restoring force F_{RH}), the tube segments 12 of the telescope 11 are pushed one inside another, with the compression spring 15 being prestressed, and locked so that the head restraint is again in its starting position.

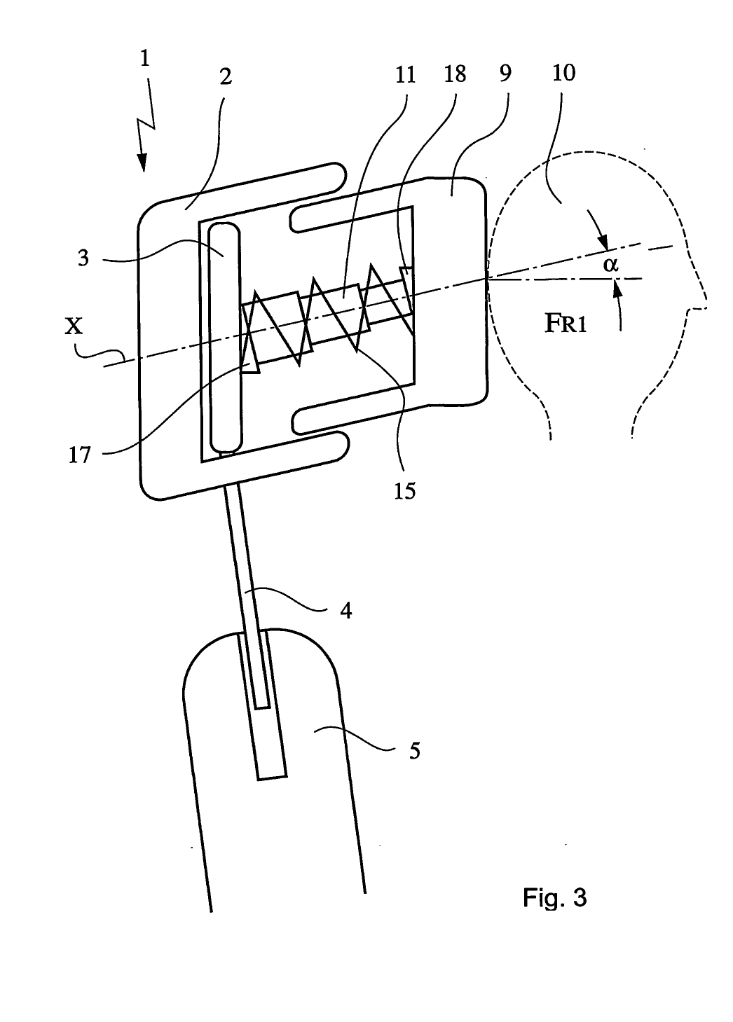

In the case of the variant according to FIG. 3, the padded segment 9 can be displaced in relation to the basic body 1 from the use position obliquely upward into the safety position illustrated, so that it is shifted not only in the direction of travel (−X direction) but additionally also vertically (+Z direction). These kinematics take account of the finding that, in order to optimize the seat occupant's comfort, head restraints are frequently set lower than required for safety considerations.

The telescope 11 is firstly fastened via a first beveled individual bracket 17 to the vertically orientated carrier element 3 and is secondly connected via a second individual bracket 18, which is beveled in an opposite direction, to the padded segment 9 and is inclined upward through an angle α of 25° with respect to the horizontal in the direction of travel. The upper and lower boundary surfaces of the recess 8 and that part of the padded segment 9 which protrudes into said recess have a contour orientated parallel to the telescope axis X in order to permit the desired displacement. The resetting force F_{R1}, which is exerted by the seat occupant's head 10 when it strikes against the padded segment, is introduced into the telescope 11 obliquely relative to the inclined telescope axis X. In the case of a telescope which consists of deep-drawn tube sections of steel sheet, which are joined to one another with a slight clearance fit (difference in diameter at maximum 50 μm), there is already sufficient locking in the telescope 11 as a consequence of an introduction of force which is inclined by an angle of 25° in relation to the telescope axis X. For other pairings of material or fits, the required inclination (and the eccentricity which is to be provided in the case of the variant described at the beginning) can be calculated in accordance with the customary rules of mechanical engineering. Of course, it is also possible to combine an inclination with an eccentric introduction of force.

1. A head restraint which is connected to a backrest (5) of a vehicle seat, having a padded segment (9) which can be changed in position relative to a basic body (1) of the head restraint and, in the event of an accident, can be shifted under the action of a force-generating device from a use position toward the seat occupant's head (10) into a safety position and can be locked therein by a fixing device, the fixing device comprises a telescope (11) which, is supported on the basic body (1) and, is connected to the shiftable padded segment (9), it being possible for the a resetting force (F_{R}) to act on the padded element to be introduced into the telescope in a direction deviating from the telescope axis (X).

2. The head restraint as claimed in claim 1, wherein the telescope (11), is supported on the basic body (1) and, is connected to the shiftable padded segment (9) by a force-transmitting device (14) which acts eccentrically with respect to the telescope axis (X).

3. The head restraint as claimed in claim 2, wherein the force-transmitting device (14) comprises a bolt which connects a flange plate (13), which is arranged on the end side of the telescope (11) in the direction of travel, and the shiftable padded segment (9) to each other eccentrically with respect to the telescope axis (X).

4. The head restraint as claimed in claim 1, wherein the telescope (11) is inclined with respect to the horizontal (X) direction of the vehicle.

5. The head restraint as claimed in claim 4, wherein the inclination of the telescope (11) is 10° to 45°,

6. The head restraint as claimed in claim 1 wherein the telescope (11) comprises at least two tube sections (12) which are displaceable one inside another.

7. The head restraint as claimed in claim 6, wherein the tube sections (12) have a circular cross section.

8. The head restraint as claimed in claim 1 wherein the force-generating device comprises at least one compression spring (15) which is prestressed into the use position.

9. The head restraint as claimed in claim 8, wherein a displacing force (spring force F_{F}) which acts centrically with respect to the telescope axis (X) is generated by the compression spring(s).

10. The head restraint as claimed in claim 9, wherein the compression spring (15) surrounds the telescope (11) coaxially with respect to the telescope axis (X).

11. The head restraint as claimed in claim 1, in order to correct the head restraint after the end of the accident situation, a restoring force (F_{RH}) which acts centrically with respect to the telescope axis (X) is applied to that end of the telescope (11) which faces the padded element (9).

12. The head restraint as claimed in claim 1, wherein the head restraint is connected to the backrest (5) by at least one holding rod (4) with the holding rod configured to adjust infinitely variably in height.

13. The head restraint as claimed in claim 1, wherein the head restraint is connected to the backrest (5) and configured to rotationally adjust infinitely variably about an axis of rotation.

14. The head restraint as claimed in claim 5, wherein the inclination of the telescope (11) is 20° to 25°.
